(19) United States
(12) Patent Application Publication
(10) Pub. No.: US 2018/0202229 A1
(43) Pub. Date: Jul. 19, 2018

(54) Drywall Compound Storage System

(71) Applicant: Mark Wood, Gillespie, IL (US)

(72) Inventor: Mark Wood, Gillespie, IL (US)

(21) Appl. No.: 15/409,008

(22) Filed: Jan. 18, 2017

(51) Int. Cl. E06C 7/14; E06C 1/14; E04G 21/00

(52) U.S. Cl. CPC E06C 7/14; E04G 21/005; E06C 1/14

(57) ABSTRACT

A drywall compound storage system includes a ladder that has a topmost step. A drywall hawk is provided and drywall compound is positioned thereon. A support is provided and the support is selectively positioned on the ladder. The drywall hawk is selectively positioned on the support such that the drywall hawk is retained in a horizontal orientation. In this way the support inhibit the drywall compound from sliding off of the drywall hawk when the drywall hawk is set on the support.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to storage devices and more particularly pertains to a new storage device for retaining a drywall hawk in a horizontal orientation when the drywall hawk is not being used.

### BRIEF SUMMARY OF THE INVENTION

An embodiment of the disclosure meets the needs presented above by generally comprising a ladder that has a topmost step. A drywall hawk is provided and drywall compound is positioned thereon. A support is provided and the support is selectively positioned on the ladder. The drywall hawk is selectively positioned on the support such that the drywall hawk is retained in a horizontal orientation. In this way the support inhibit the drywall compound from sliding off of the drywall hawk when the drywall hawk is set on the support.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a support of a drywall compound storage system according to an embodiment of the disclosure.

FIG. 2 is a bottom view of a support of an embodiment of the disclosure.

FIG. 3 is an exploded perspective view of support and a drywall hawk of an embodiment of the disclosure.

FIG. 4 is a right side view of a support and a drywall hawk of an embodiment of the disclosure.

FIG. 5 is a perspective in-use view of an embodiment of the disclosure.

### DETAILED DESCRIPTION OF THE INVENTION

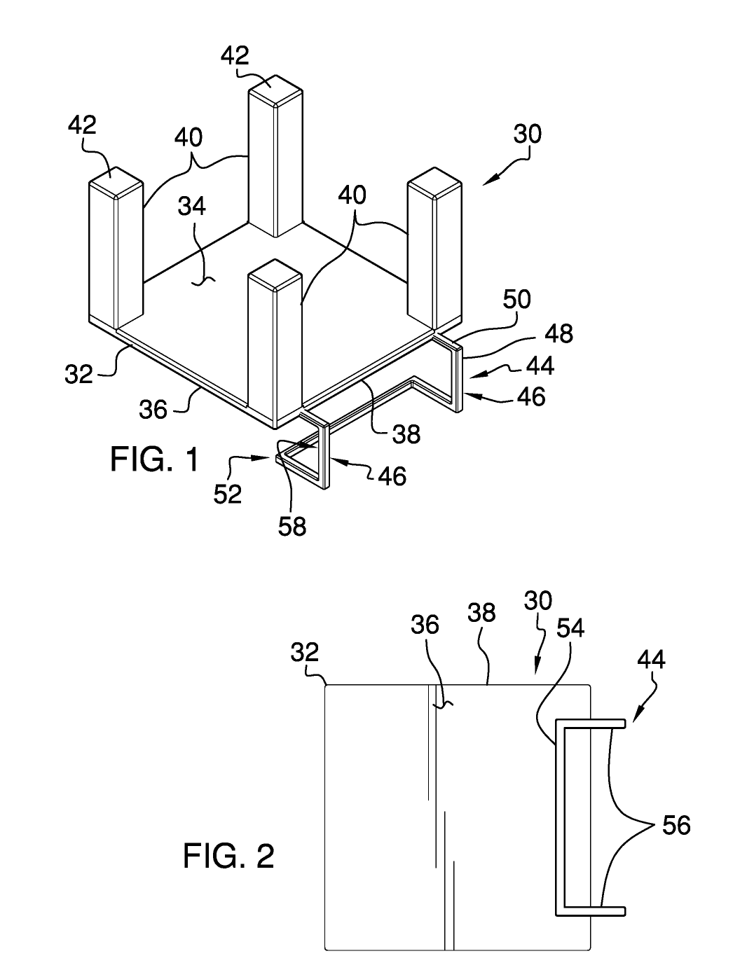

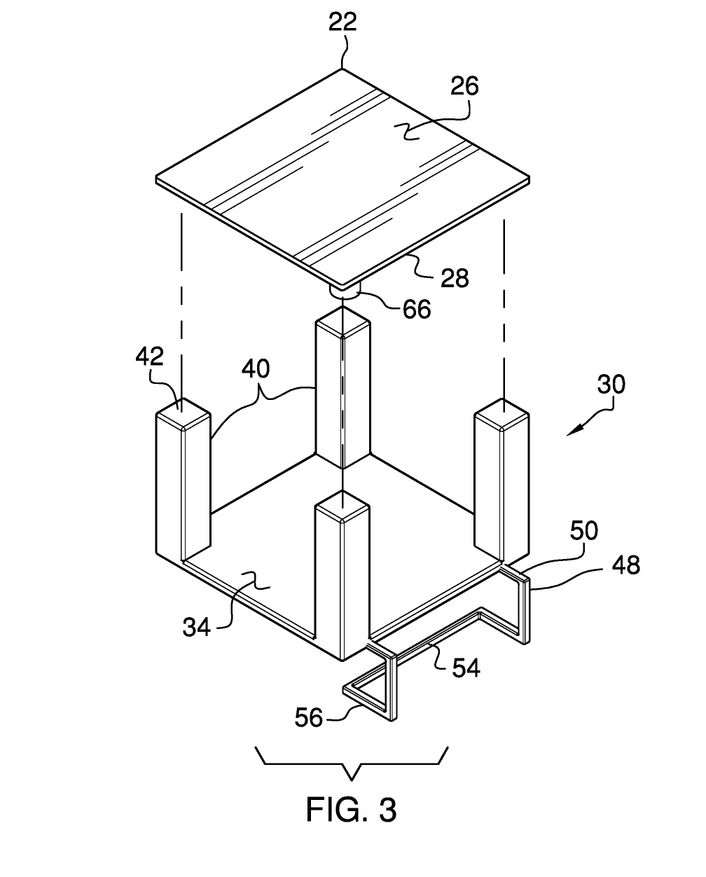

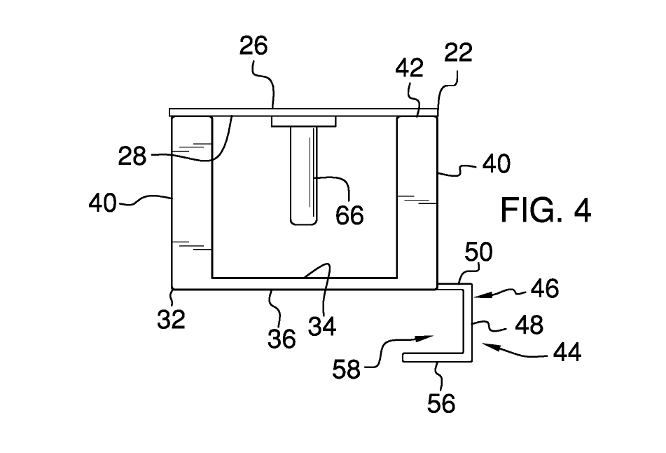

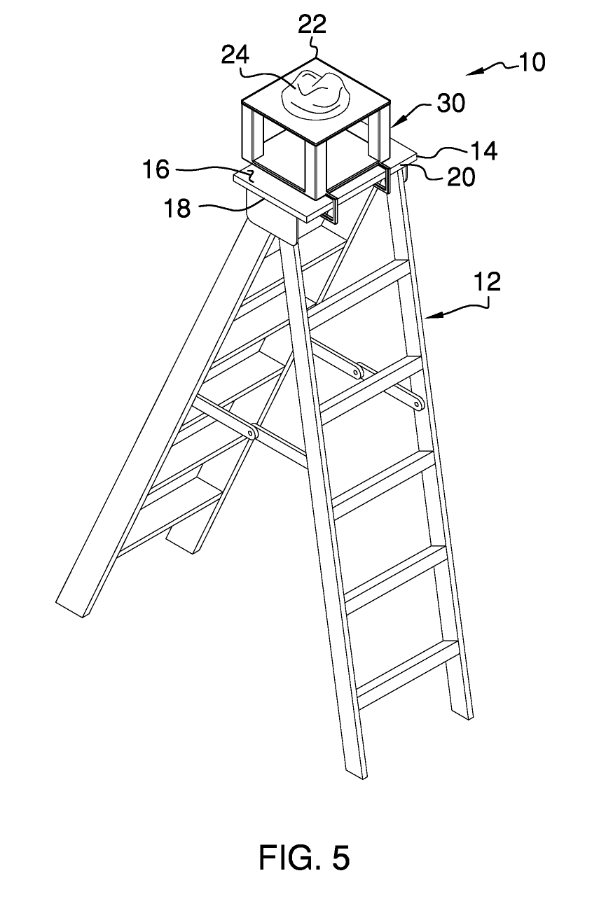

With reference now to the drawings, and in particular to FIGS. 1 through 5 thereof, a new storage device embodying the principles and concepts of an embodiment of the disclosure and generally designated by the reference numeral 10 will be described.

As best illustrated in FIGS. 1 through 5 the drywall compound storage system 10 generally comprises a ladder 12 that has a topmost step 14. The topmost step 14 has a top surface 16, a bottom surface 18 and an outer edge 20. The ladder 12 may be a step ladder, an extension ladder or any other type of ladder 12. A drywall hawk 22 is provided and drywall compound 24 positioned on the drywall hawk 22 when the drywall compound 24 is being applied to drywall. The drywall hawk 22 has an upper surface 26 and a lower surface 28 and the drywall hawk 22 may be a drywall hawk of any conventional design.

A support 30 is provided and the support 30 selectively positioned on the ladder 12. The drywall hawk 22 is selectively positioned on the support 30 such that the drywall hawk 22 is retained in a horizontal orientation. In this way the support 30 inhibits the drywall compound 24 from sliding off of the drywall hawk 22 when the drywall hawk 22 is set on the support 30.

The support 30 comprises a plate 32 has a first surface 34, a second surface 36 and a peripheral edge 38 extending therebetween. The second surface 36 selectively abuts the top surface 16 of the topmost step 14 on the ladder 12. A plurality of pegs 40 is provided and each of the pegs 40 is coupled to and extends upwardly from the first surface 34. Each of the pegs 40 is aligned with an associated one of four corners of the plate 32 and each of the pegs 40 has a distal end 42 with respect to the plate 32. The lower surface 28 of the drywall hawk 22 lies on the distal end 42 corresponding to each of the pegs 40 when the drywall hawk 22 is positioned on the support 30. Additionally, the pegs 40 space 58 the drywall hawk 22 above the plate 32 thereby inhibiting a handle on the drywall hawk 22 from engaging the plate 32.

A grip 44 is coupled to the peripheral edge 38 of the plate 32. The grip 44 removably engages the topmost step 14 of the ladder 12 when the plate 32 is positioned on the topmost step 14. Thus, the grip 44 inhibits the plate 32 from falling off of the ladder 12. The grip 44 comprises a pair of first sections 46 and each of the first sections 46 includes a leg 48 and a foot 50. The foot 50 corresponding to each of the first sections 46 is coupled to and extends outwardly from the peripheral edge 38 of the plate 32. Moreover, the first sections 46 are spaced apart from each other.

The grip 44 further includes a second section 52 that has a central member 54 extending between a pair of lateral members 56. The lateral members 56 are spaced apart from each other on the central member 54. Each of the lateral members 56 is coupled to the leg 48 corresponding to each of the first sections 46. The central member 54 is spaced from the second surface 36 of the plate 32 to define a space 58 between each of the lateral members 56 and the foot 50 corresponding to each of the first sections 46. The space 58 receives the outer edge 20 of the topmost step 14 on the ladder 12 and the central member 54 abuts the bottom surface 18 of the topmost step 14. In this way the plate 32 is removably retained on the topmost step 14.

In use, the support 30 is positioned on the topmost step 14 of the ladder 12 when the drywall compound 24 is being applied to the drywall. The drywall hawk 22 is manipulated in the convention of applying the drywall compound 24 to the drywall. The drywall hawk 22 is selectively positioned on the support 30 to facilitate a user to perform other activities. The support 30 retains the drywall hawk 22 in a horizontal orientation thereby inhibiting the drywall compound 24 from sliding off of the drywall hawk 22. In this way the user is facilitated to perform multiple duties while the drywall compound 24 is being applied to the drywall without spilling the drywall compound 24 on a floor or the like.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A drywall compound storage system comprising:
a ladder having a topmost step;
a drywall hawk being configured to have drywall compound positioned thereon; and
a support being selectively positioned on said ladder, said drywall hawk being selectively positioned on said support such that said drywall hawk is retained in a horizontal orientation wherein said support is configured to inhibit the drywall compound from sliding off of said drywall hawk when said drywall hawk is set on said support, said support including a plate having a first surface, a second surface and a peripheral edge extending therebetween, said second surface selectively abutting said top surface of said topmost step on said ladder; and
a plurality of pegs, each of said pegs being coupled to and elongated extending upwardly from said first surface, each of said legs being aligned with an associated one of four corners of said plate and spaced apart defining openings extending up from said first surface between adjacent pairs of said pegs, each of said pegs having a distal end with respect to said plate, a lower surface of said drywall hawk lying on said distal end corresponding to each of said pegs when said drywall hawk is positioned on said support.

2. (canceled)

3. (canceled)

4. The system according to claim 1, further comprising:
a plate having a peripheral edge and a second surface;
a grip being coupled to said peripheral edge of said plate, said grip removably engaging a topmost step of said ladder when said plate is positioned on said topmost step such that said grip inhibits said plate from falling off of said ladder.

5. The system according to claim 4, wherein said grip comprises a pair of first sections, each of said first sections including a leg and a foot, said foot corresponding to each of said first sections being coupled to and extending outwardly from said peripheral edge of said plate, said first sections being spaced apart from each other.

6. The system according to claim 5, further comprising a second section having a central member extending between a pair of lateral members, said lateral members being spaced apart from each other, each of said lateral members being coupled to said leg corresponding to each of said first sections having said central member being spaced from said second surface of said plate to define a space between each of said lateral members and said foot corresponding to each of said first sections.

7. The system according to claim 6, wherein:
said topmost step has an outer edge and a bottom surface; and
said space receives said outer edge of said topmost step on said ladder having said central member abutting said bottom surface of said topmost step such that said plate is removably retained on said topmost step.

8. A drywall compound storage system comprising:
a ladder having a topmost step, said topmost step having a top surface, a bottom surface and an outer edge;
a drywall hawk being configured to have drywall compound positioned thereon, said drywall hawk having an upper surface and a lower surface; and
a support being selectively positioned on said ladder, said drywall hawk being selectively positioned on said support such that said drywall hawk is retained in a horizontal orientation wherein said support is configured to inhibit the drywall compound from sliding off of said drywall hawk when said drywall hawk is set on said support, said support comprising:
a plate having a first surface, a second surface and a peripheral edge extending therebetween, said second surface selectively abutting said top surface of said topmost step on said ladder,
a plurality of pegs, each of said pegs being coupled to and elongated extending upwardly from said first surface, each of said legs being aligned with an associated one of four corners of said plate and spaced apart defining openings extending up from said first surface between adjacent pairs of said pegs, each of said pegs having a distal end with respect to said plate, said lower surface of said drywall hawk lying on said distal end corresponding to each of said pegs when said drywall hawk is positioned on said support, and
a grip being coupled to said peripheral edge of said plate, said grip removably engaging said topmost step of said ladder when said plate is positioned on said topmost step such that said grip inhibits said plate from falling off of said ladder, said grip comprising:
a pair of first sections, each of said first sections including a leg and a foot, said foot corresponding to each of said first sections being coupled to and extending outwardly from said peripheral edge of said plate, said first sections being spaced apart from each other, and
a second section having a central member extending between a pair of lateral members, said lateral members being spaced apart from each other, each of said lateral members being coupled to said leg corresponding to each of said first sections having said central member being spaced from said second surface of said plate to define a space between each of said lateral members and said foot corresponding to each of said first sections, said space receiving said outer edge of said topmost step on said ladder having said central member abutting said bottom surface of said topmost step such that said plate is removably retained on said topmost step.
